(19) United States
(12) Patent Application Publication
(10) Pub. No.: US 2023/0378690 A1
(43) Pub. Date: Nov. 23, 2023

(54) COMPUTER POWER CORD RETENTION DEVICE

(71) Applicant: Mavinga Baku, Nort h York (CA)

(72) Inventor: Mavinga Baku, Nort h York (CA)

(21) Appl. No.: 17/664,073

(22) Filed: May 19, 2022

(51) Int. Cl. H01R 13/639

(52) U.S. Cl. CPC H01R 13/639

(57) ABSTRACT

A computer cord retention device that is configured to ensure maintenance of a power cord position when operably coupled to a power support port. The present invention is provided in two embodiments wherein the first embodiment includes a body having a hingedly coupled first half and second half. The first half and second half are arcuate in shape forming a cavity in the body in the closed position sufficient in size to accommodate a power cord therein. In the closed position of the body, clamping members present at opposing ends of the body bias a power cord so as to inhibit movement thereof. The second embodiment includes planar body having a first and second portion wherein the second portion forms a T-shape. The body includes a plurality of clamping members extending upward from the first portion that are operable to bend downwards and bias against a power cord.

### FIELD OF THE INVENTION

The present invention relates generally to computer accessories, more specifically but not by way of limitation, a cord management apparatus that is configured to be operably coupled to a laptop computer wherein the present invention provides releasable securing of the power cord to the laptop in order to inhibit unintended disconnection.

### BACKGROUND

As is known in the art, laptop computers are routinely utilized by millions of individuals both for commercial and recreational purposes. The advances in computer processing speed and other technologies have made the portable laptop preferred for many reasons. In the commercial environment individuals can now take their laptop computer with them so as to engage in use thereof for meetings and other events. Common uses can include but are not limited utilization of laptop at meetings wherein several individuals are sharing information being displayed on the laptop. Recent macro-economical trends now have more people working remotely and as such utilization and dependency on laptop performance is increasing.

The increase in utilization of the laptop has introduced several challenges. Laptops are powered by batteries and as such need routine charging. Depending upon the type of laptop and the applications being executed thereon, battery life can be an issue as depletion thereof can be a constraint to desired productivity levels. One issue with existing laptops is power cord management. The conventional power cord for laptops electrically couple the battery to a power source. Commonly, the laptop connection is either magnetic or a conventional round plug that is releasably secured with friction. A commonly faced problem is the maintenance of the power cord connection with the laptop. It is quite often that the power cord can become disconnected from the laptop often without the user being aware. This disconnection can result in battery loss and potentially loss of data.

Accordingly, there is a need for a device that provides securing of a power cord to a laptop so as to inhibit the accidental disconnection of the laptop power cord with the laptop.

### SUMMARY OF THE INVENTION

It is the object of the present invention to provide a laptop power cord retention device configured to secure a power cord connection to the laptop wherein the present invention includes a first embodiment and a second embodiment.

Another object of the present invention is to provide a device configured to ensure maintenance of the connection of a power cord and a laptop computer wherein the first embodiment includes a first portion and a second portion that are perpendicular in orientation and contiguously formed.

A further object of the present invention is to provide a laptop power cord retention device configured to secure a power cord connection to the laptop wherein the first embodiment of the present invention includes mateable halves wherein the mateable halves are movably coupled.

Still another object of the present invention is to provide a device configured to ensure maintenance of the connection of a power cord and a laptop computer wherein the first embodiment includes an opening at distal ends and is substantially hollow in its closed position.

An additional object of the present invention is to provide a laptop power cord retention device configured to secure a power cord connection to the laptop wherein the first embodiment includes a downward clamping member integrally formed into each of the opposing ends.

Yet a further object of the present invention is to provide a device configured to ensure maintenance of the connection of a power cord and a laptop computer wherein the second embodiment includes a body that is planar in manner having a first portion and a second portion that are T-shaped in configuration.

Another object of the present invention is to provide a laptop power cord retention device configured to secure a power cord connection to the laptop wherein the body of the second embodiment includes an upper surface.

Still another object of the present invention is to provide a device configured to ensure maintenance of the connection of a power cord and a laptop computer wherein the second embodiment includes a plurality of clamping members formed on the opposing outer edges of the first portion wherein the clamping members extend upward from the upper surface.

An additional object of the present invention is to provide a laptop power cord retention device configured to secure a power cord connection to the laptop wherein the clamping members of the second embodiment are movable between a first position and a second position.

Yet another object of the present invention is to provide a device configured to ensure maintenance of the connection of a power cord and a laptop computer wherein the first portion and second portion of the second embodiment have a ninety degree offset with respect to each other.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of a first half of the first embodiment of the present invention; and

FIG. 2 is a perspective view of the first embodiment of the present invention in its closed position; and

FIG. 3 is a top view of the first embodiment of the present invention in its open position; and

FIG. 4 is a perspective view of the first embodiment of the present invention operably coupled to an exemplary laptop; and

FIG. 5 is a diagrammatic perspective view of the second embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a computer cord retention apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

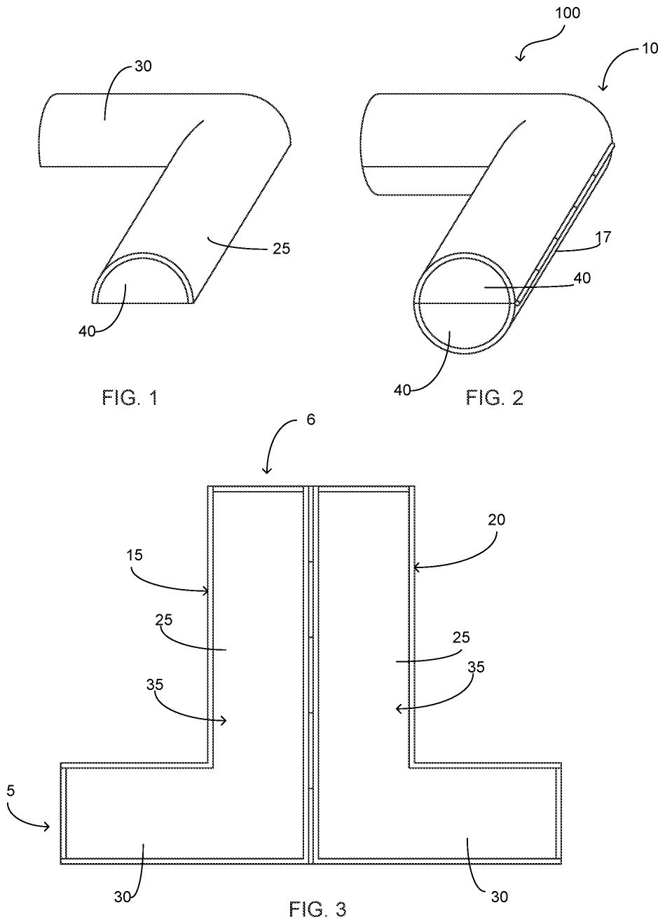

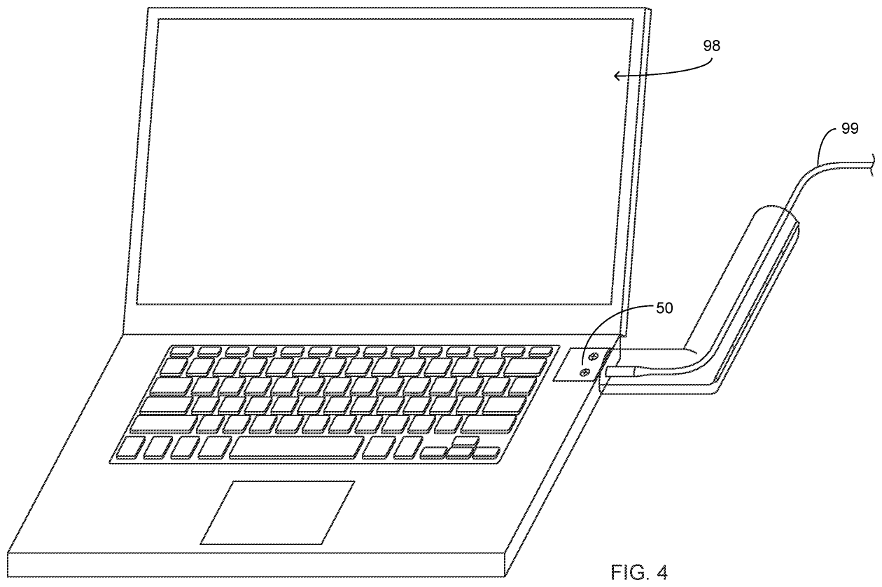

Referring in particular to the Figures submitted as a part hereof, computer cord retention apparatus 100 includes a first embodiment that is illustrated herein in FIG. 1 through FIG. 4. The computer cord retention apparatus 100 includes a body 10 wherein the body 10 includes a first half 15 and a second half 20. The first half 15 and second half 20 are manufactured from a durable rigid material such as but not limited to plastic. The first half 15 and second half 20 are identically formed each having a first portion 25 and second portion 30 wherein the first portion 25 and second portion 30 are contiguously formed. The first portion 25 and second portion 30 are formed in a perpendicular manner. While the first embodiment of the computer cord retention apparatus 100 illustrated herein shows a L-shape, it should be understood within the scope of the present invention that the first portion 25 and second portion 30 could be formed in alternate shapes. The body 10 is movable between an open position, illustrated herein in FIG. 3 and a closed position illustrated herein in FIG. 2. A hinge 17 is coupled to the first half 15 and second half 20 wherein the hinge 17 is configured to facilitate movement of the body 10 between its open position and closed position.

Both the first half 15 and second half 20 are arcuate in shape wherein first half 15 and second half 20 are formed in a semi-annular form. This formed shape of the first half 15 and second half 20 creates a cavity 35 when the first half 15 and second half 20 are moved to the closed position of the computer cord retention apparatus 100 as is illustrated herein in FIG. 2. The cavity 35 is sufficient in size so as to accommodate a power cord therein. Formed at each end 5, 6 of the body 10 is a clamping member 40. The clamping member 40 is semi-annular in shape and configured to extend inward so as to provide closure each end 5,6 when the body 10 is moved to its closed position. The clamping members 40 function to apply pressure to a cord 99 that has been placed in the computer cord retention apparatus 100 wherein the pressure on the cord 99 is sufficient to inhibit the movement thereof. A securing plate member 50 is operably coupled to the body 10 and further mechanically coupled to the laptop 98 proximate a power support access port. The securing plate member 50 is planar in manner and mechanically fastened to the laptop 98 utilizing suitable techniques. The securing plate member 50 ensures the computer cord retention apparatus 100 remains stationary with respect to the laptop 98 and as such the power cord 99 disposed therein. It should be understood within the scope of the present invention that the body 10 could be secured to the laptop 98 utilizing alternate elements in order to achieve the desired objective of a secure immovable connection with the laptop 98.

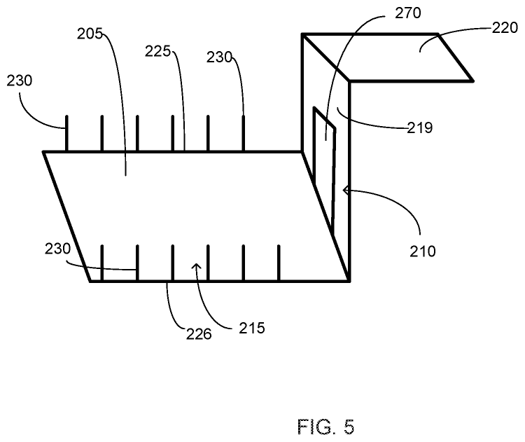

Referring now to FIG. 5 herein the second embodiment of the computer cord retention apparatus 200 is illustrated therein. The computer cord retention apparatus 200 includes a body 210 wherein the body 210 is planar in manner and manufactured from a rigid material such as but not limited to metal. The body 210 is configured to provide support for a power cord 99 on the upper surface 215 thereof. It should be understood within the scope of the present invention that the body 210 could be provided in alternate sizes. The body 210 includes a first portion 205 and a second portion 220 wherein the first portion 205 and second portion 220 are contiguously formed. The second portion 220 forms a L-shape with the first portion 205 in a preferred embodiment but it should be understood within the scope of the present invention that the body 210 could be provided in alternate shapes.

The first portion 205 includes opposing longitudinal edges 225,226. Movably secured to the longitudinal edges 225,226 are a plurality of clamping members 230. The clamping members 230 are formed to extend upward from the upper surface 215 of the first portion 205. The clamping members 230 are rectangular in shape and are manufactured from a suitable bendable material such as but not limited to metal. The clamping members 230 are movable between a first position and a second position. In the first position, the clamping members 230 extend upward as is illustrated herein in FIG. 5. In the second position, the clamping members 230 are bent downwards towards the upper surface 215 of the first portion 205 so as to be substantially adjacent thereto. It is in the second position that the clamping members 230 are utilized to releasably secure a power cord 99 positioned on the upper surface 215 wherein the clamping members 230 will bias against a power cord 99 superposed on the upper surface 215 of the first portion 205.

It is contemplated within the scope of the present invention that the computer cord retention apparatus 200 could be provided with an alternate quantity of clamping members 230. By way of example but not by limitation, the computer cord retention apparatus 200 could be provided with as few as one clamping member 230 or a plurality of clamping members 230 as is illustrated herein. The second portion 220 is offset from the first portion 205 having a ninety-degree offset thereto. The ninety-degree offset between the second portion 220 and first portion 205 facilitates installation on the laptop 98 allowing the clamping members 230 to be oriented in the upwards direction in their first position. While not particularly illustrated herein, it is contemplated within the scope of the present invention that the upper surface 215 have disposed thereon an adhesive such as but not limited to a pressure sensitive adhesive in order to ensure securing of the power cord 99 thereto. Formed in the second portion 220 in the lower section 219 thereof is aperture 270. Aperture 270 is provided so as to superposed a power supply port of the laptop 98 so as to provide access thereto. It should be understood within the scope of the present invention that the aperture 270 could be provided in alternate shapes and sizes.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A laptop power cord retention device configured to inhibit the laptop power cord from being disconnected from a laptop computer wherein the laptop power cord retention device comprises:
a body, said body having a first half and a second half, said first half and said second half of said body being hingedly coupled, said body having a first position and a second position, said body having a first end and a second end, said body forming a cavity in said closed position, said cavity operable to the laptop power cord extend therethrough;
clamping members, said clamping members being formed on said first end and said second end, said clamping members extending downward in the closed position of the body; and
wherein said clamping members are operable to bias against the laptop power cord extending through the first end and second end of the body.

2. The laptop power cord retention device as recited in claim 1, wherein said first half of said body includes a wall that is arcuate in shape.

3. The laptop power cord retention device as recited in claim 2, and further including a securing member, said securing member being planar in manner, said securing member being operably coupled to said body, said securing member configured to be secured to the laptop computer.

4. The laptop power cord retention device as recited in claim 3, wherein said second half of said body includes an outer wall that is arcuate in shape.

5. The laptop power cord retention device as recited in claim 4, wherein said body is L-shaped.

6. A laptop power cord retention device configured to secure a power supply cord to a laptop to inhibit removal thereof wherein the laptop power cord retention device comprises:
a body, said body having a first portion and a second portion, said first portion of said body being planar in manner, said first portion of said body being rectangular in shape, said first portion of said body having a first longitudinal edge and a second longitudinal edge, said first portion of said body having an upper surface, said second portion of said body having a lower section and an upper section, said lower section of said second portion being contiguously formed with said first portion of said body, said lower section of said second portion of said body being perpendicular to said first portion of said body extending upwards with respect thereto, said second section of said second portion of said body being contiguous with said first section of said second portion of said body, said second section of said second portion of said body being perpendicular to said first section of said second portion; and
at least one clamping member, said at least one clamping member being secured to said first portion of said body, said at least one clamping member being configured to move between a first position and a second position, said at least one clamping member operable to bias the power supply cord against the upper surface of said first portion of said body.

7. The laptop power cord retention device configured to secure a power supply cord to a laptop as recited in claim 6, and further including an aperture, said aperture being formed in the first section of said second portion of said body, and said aperture configured to provide access to a power supply port.

8. The laptop power cord retention device configured to secure a power supply cord to a laptop as recited in claim 7, wherein the at least one clamping member is mounted to the first longitudinal edge of the first portion of said body.

9. The laptop power cord retention device configured to secure a power supply cord to a laptop as recited in claim 8, wherein in said first position, said at least one clamping member is positioned to extend upward from the upper surface of said first portion of said body being perpendicular thereto.

10. The laptop power cord retention device configured to secure a power supply cord to a laptop as recited in claim 9, wherein in said second position, the at least one clamping member is moved so as to be adjacent the upper surface of said first portion of said body.
